(19) United States
(12) Patent Application Publication
(10) Pub. No.: US 2024/0282197 A1
(43) Pub. Date: Aug. 22, 2024

(54) DATA SHARING METHOD, ON-VEHICLE DEVICE, CLOUD SERVER, SYSTEM, APPARATUS AND MEDIUM

(71) Applicants: Beijing BOE Technology Development Co., Ltd., Beijing (CN); BOE TECHNOLOGY GROUP CO., LTD., Beijing (CN)

(72) Inventors: Youxiang XIA, Beijing (CN); Shuobin LIANG, Beijing (CN); Honglei ZHANG, Beijing (CN); Xiao CHU, Beijing (CN); Yangyang ZHANG, Beijing (CN); Hongbo FENG, Beijing (CN)

(21) Appl. No.: 18/024,528

(22) PCT Filed: Mar. 25, 2022
(86) PCT No.: PCT/CN2022/083076

§ 371 Date: Mar. 3, 2023

(51) Int. Cl. G08G 1/16; G08G 1/0967

(52) U.S. Cl. CPC G08G 1/164; G08G 1/0967; G08G 1/167

(57) ABSTRACT

The present disclosure provides a data sharing method, an on-vehicle device, a cloud server, an internet-of-vehicle system, an electronic apparatus, and a computer-readable medium. The data sharing method is applied to the on-vehicle device. The method includes: determining whether there is a sensing blind region around the on-vehicle device based on road condition information acquired by the on-vehicle device in response to a distance between the on-vehicle device and a key road node smaller than a predetermined distance; if there is the sensing blind region around the on-vehicle device, acquiring road condition information of the sensing blind region acquired by an auxiliary equipment; and performing a driving guidance based on the road condition information acquired by the on-vehicle device and the road condition information of the sensing blind region.

### TECHNICAL FIELD

The present disclosure relates to the field of internet-of-vehicle technology, and particularly relates to a data sharing method, an on-vehicle device, a cloud server, an internet-of-vehicle system, an electronic apparatus and a computer readable medium.

### BACKGROUND

At present, an autonomous vehicle acquires information of a surrounding driving environment by using a sensor, determines whether the vehicle is in a safe state during a driving process according to the information, and performs a danger avoiding operation in time when an abnormal condition exists. However, for complex road traffic, due to the limitation of the installation position of the sensor of the vehicle, a sensing blind region which cannot be sensed by the sensor may be present around the vehicle, and in this case, if an emergency occurs in the sensing blind region, the vehicle cannot avoid danger easily, which results in a traffic accident.

### SUMMARY

The present disclosure is directed to at least one of the technical problems in the prior art, and provides a data sharing method, an on-vehicle device, a cloud server, an internet-of-vehicle system, an electronic apparatus, and a computer-readable medium.

In a first aspect, the present disclosure provides a data sharing method applied to an on-vehicle device and including: determining whether there is a sensing blind region around the on-vehicle device based on road condition information acquired by the on-vehicle device in response to a distance between the on-vehicle device and a key road node being smaller than a predetermined distance; in response to there being the sensing blind region around the on-vehicle device, obtaining road condition information of the sensing blind region acquired by an auxiliary equipment; and performing a driving guidance based on the road condition information acquired by the on-vehicle device and the road condition information of the sensing blind region.

In some embodiments, the auxiliary equipment at least includes: a road detection device, and the obtaining of the road condition information of the sensing blind region acquired by the auxiliary equipment includes: determining whether there is the road detection device in a preset distance from the key road node, sending first request information to the road detection device to request to obtain first road condition information acquired by the road detection device, in response to there being the road detection device in the preset distance from the key road node; receiving the first road condition information acquired by the road detection device; and detecting whether there is a target on-vehicle device capable of acquiring the road condition information of the sensing blind region in response to there being no road detection device in the preset distance from the key road node.

In some embodiments, the method further includes: determining whether the first road condition information includes the road condition information of the sensing blind region, detecting whether there is a target on-vehicle device capable of acquiring the road condition information of the sensing blind region in response to the first road condition information not comprising the road condition information of the sensing blind region; and obtaining the road condition information of the sensing blind region acquired by the target on-vehicle device, in response to there being the target on-vehicle device.

In some embodiments, the obtaining of the road condition information of the sensing blind region acquired by the target on-vehicle device, includes: sending second request information to the target on-vehicle device to request the target on-vehicle device to provide second road condition information, wherein the second road condition information includes the road condition information of the sensing blind region; and receiving the second road condition information provided by the target on-vehicle device.

In some embodiments, the obtaining of the road condition information of the sensing blind region acquired by the target on-vehicle device includes: detecting device information of the target on-vehicle device; sending third request information to a cloud server based on the device information to request the cloud server to provide third road condition information, wherein the third road condition information includes the road condition information of the sensing blind region acquired by the target on-vehicle device; and receiving the third road condition information provided by the cloud server.

In some embodiments, the obtaining of the road condition information of the sensing blind region acquired by the auxiliary equipment includes: acquiring current time, current position information of the on-vehicle device and a position and a range of the sensing blind region; sending the current time, the current position information and the position and the range of the sensing blind region to a cloud server, so that the cloud server determines reference road condition information matched with the current time and the current position information based on a first mapping relationship, and determines the road condition information of the sensing blind region based on the reference road condition information and the position and the range of the sensing blind region; and receiving the road condition information of the sensing blind region sent by the cloud server, wherein the first mapping relationship indicates a mapping relationship among the current time, the current position and the road condition information sent to the cloud server by other on-vehicle devices.

In some embodiments, the method further includes sending reminding information in response to an emergency information acquired by the on-vehicle device.

In a second aspect, embodiments of the present disclosure provide a data sharing method applied to a cloud server and including: receiving request information sent by a first on-vehicle device, wherein the request information is information that requests road condition information of a sensing blind region, and the request information includes: a position and a range of the sensing blind region; and sending at least the road condition information of the sensing blind region acquired by a second on-vehicle device to the first on-vehicle device based on the request information.

In some embodiments, the request information further includes: device information of the second on-vehicle device; and the sending of at least the road condition information of the sensing blind region acquired by the second on-vehicle device to the first on-vehicle device based on the request information includes: sending all road condition information acquired by the second on-vehicle device to the first on-vehicle device based on the request information.

In some embodiments, the sending of at least the road condition information of the sensing blind region acquired by the second on-vehicle device to the first on-vehicle device based on the request information includes: determining road condition information of the sensing blind region from the all road condition information acquired by the second on-vehicle device based on the request information; and sending the road condition information of the sensing blind region to the first on-vehicle device.

In some embodiments, the method further includes: prior to receiving the request information sent by the first on-vehicle device, establishing a first mapping relationship based on current time, current position and road condition information uploaded by other on-vehicle devices, wherein the request information further includes: the current time and the current position information of the first on-vehicle device, the sending of at least the road condition information of the sensing blind region acquired by the second on-vehicle device to the first on-vehicle device based on the request information includes: determining reference road condition information matched with the current time and the current position information based on the first mapping relationship, and determining the road condition information of the sensing blind region based on the reference road condition information and the position and the range of the sensing blind region; and sending the road condition information of the sensing blind region to the first on-vehicle device.

In a third aspect, embodiments of the present disclosure provides an on-vehicle device, including: a road condition information acquisition component configured to acquire road condition information; a determination component configured to, in response to a distance between the on-vehicle device and a key road node being smaller than a predetermined distance, determine whether there is a sensing blind region around the on-vehicle device based on the road condition information acquired by the on-vehicle device; a blind region information obtaining component configured to obtain road condition information of the sensing blind region acquired by an auxiliary equipment in a case where there is the sensing blind region around the on-vehicle device; and a guidance component configured to perform a guidance driving based on the road condition information acquired by the road condition information acquisition component and the road condition information of the sensing blind region.

In a fourth aspect, embodiments of the present disclosure provide a cloud server including: a receiving component configured to receive request information sent by a first on-vehicle device, wherein the request information is information that requests road condition information of a sensing blind region, and the request information includes: a position and a range of the sensing blind region; and a sending component configured to send at least the road condition information of the sensing blind region acquired by a second on-vehicle device to the first on-vehicle device based on the request information.

In a fifth aspect, embodiments of the present disclosure provide an internet-of-vehicle system including: the on-vehicle device described above and the cloud server described above.

In a sixth aspect, embodiments of the present disclosure provide an electronic apparatus, including: one or more processors; a memory having one or more programs stored thereon that, when executed by the one or more processors, cause the one or more processors to implement the method described above; one or more I/O interfaces coupled between the one or more processors and the memory and configured to implement information interaction between the one or more processors and the memory.

In a seventh aspect, embodiments of the present disclosure provide a computer-readable medium, on which a computer program is stored, wherein when being executed by a processor, the computer program implements the method the method described above.

### BRIEF DESCRIPTION OF DRAWINGS

The accompanying drawings, which are provided for further understanding of the present disclosure and constitute a part of this specification, are for explaining the present disclosure together with the embodiments of the present disclosure, but are not intended to limit the present disclosure. In the drawings:

FIG. 1 is a schematic diagram of a data sharing method according to some embodiments of the present disclosure.

FIG. 2 is a schematic diagram of a driving process of a vehicle in an example.

FIG. 3 is a flowchart of an optional implementation of Step S20 according to some embodiments of the present disclosure.

FIG. 4A is a flowchart of an optional implementation of Step S25 according to some embodiments of the present disclosure.

FIG. 4B is a flowchart of an optional implementation of Step S25 according to other embodiments of the present disclosure.

FIG. 5 is a flowchart of an optional implementation of Step S20 according to other embodiments of the present disclosure.

FIG. 6 is a schematic diagram of driving of a vehicle according to some embodiments of the present disclosure.

FIG. 7 is a schematic diagram of a data sharing method according to other embodiments of the present disclosure.

FIG. 8 is a schematic diagram of an on-vehicle device according to some embodiments of the present disclosure.

FIG. 9 is a schematic diagram of a cloud server according to some embodiments of the present disclosure.

FIG. 10 is a schematic diagram of an internet-of-vehicle system according to some embodiments of the present disclosure.

FIG. 11 is a schematic diagram of an electronic apparatus according to some embodiments of the present disclosure.

### DETAIL DESCRIPTION OF EMBODIMENTS

In order to enable one of ordinary skill in the art to better understand the technical solutions of the present disclosure, the present disclosure will be described in further detail with reference to the accompanying drawings and the detailed description.

Unless defined otherwise, technical or scientific terms used herein shall have the ordinary meaning as understood by one of ordinary skill in the art to which the present disclosure belongs. The term “first”, “second,” or the like used in the present disclosure is not intended to indicate any order, quantity, or importance, but rather is used to distinguish one element from another. Also, the term “a”, “an”, “the” or similar referent does not denote a limitation of quantity, but rather denote the presence of at least one. The word “comprise”, “include”, or the like, means that the element or item preceding the word includes the element or item listed after the word and its equivalent, but does not exclude other elements or items.

An autonomous vehicle acquires data around the autonomous vehicle (or referred to as surrounding data) by using a sensor, and determines a surrounding environment based on the acquired data. For example, the autonomous vehicle performs the following operation: acquiring the surrounding data by a sensor such as a camera, establishing a virtual map of the surrounding environment of the vehicle based on data analysis, determining driving factors (such as a vehicle speed, a distance and the like) of surrounding traffic participants based on the established virtual three-dimensional information, or acquiring point cloud information of the surrounding environment of the vehicle by a laser radar, generating surrounding environment factors by three-dimensional processing, determining whether the vehicle is in a safe state in the driving process based on the information acquired by the sensor, and performing a danger avoiding operation in time when an abnormal condition exists. However, the installation positions of the vehicle sensors are limited, for example, the cameras are installed only around the vehicle, and the laser radar is installed on the roof or other parts, so that for complex road traffic, a sensing blind region which cannot be sensed by the sensors may appear around the vehicle. For example, a truck or a bus is located in a position close to a lane, and in this case, effective information which can be acquired is only information of vehicles around the lane but information of other lanes shielded by the truck or the bus cannot be acquired (the shielded region is the sensing blind region). In this case, if an emergency occurs in the sensing blind region, the vehicle cannot avoid danger easily, which results in a traffic accident.

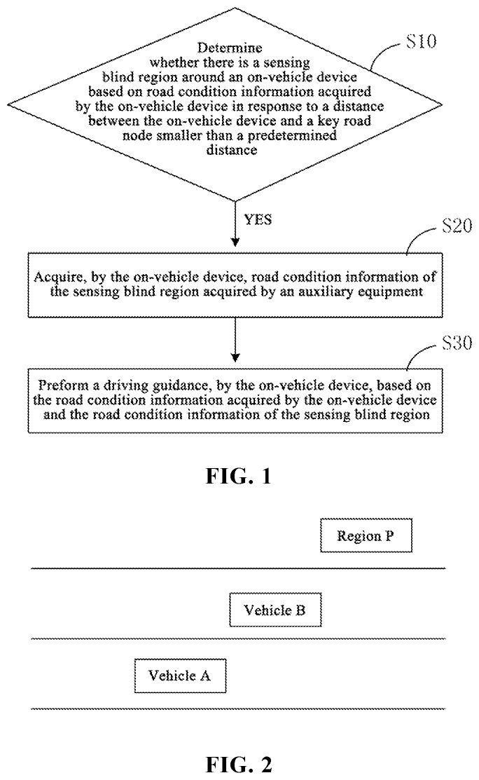

FIG. 1 is a schematic diagram of a data sharing method according to some embodiments of the present disclosure. The data sharing method is applied to an on-vehicle device. As shown in FIG. 1, the data sharing method includes Steps S10 to S30.

Step S10 includes determining whether there is a sensing blind region around an on-vehicle device based on road condition information acquired by the on-vehicle device in response to a distance between the on-vehicle device and a key road node being smaller than a predetermined distance, and if so, executing Step S20.

It should be noted that the on-vehicle device may monitor the road condition information around the vehicle in real time by sensors such as cameras, the road condition information may include driving factors such as a distance from surrounding traffic participants. In some situations, there may be a large obstacle around the vehicle, for example, a vehicle or a building that is larger than the vehicle, or the installation position of the sensor is limited, and in these cases, the signal received from or transmitted to the sensor of the on-vehicle device may be blocked by the obstacle, resulting in that the road condition information of a part of the region around the road cannot be sensed by the on-vehicle device of the vehicle, and the region blocked by the obstacle refers to the “sensing blind region” for the vehicle.

FIG. 2 is a schematic diagram of a driving process of a vehicle in an example. As shown in FIG. 2, assuming that vehicle B is a large-size vehicle, when vehicle A drives to a position shown in FIG. 2, a road condition in a region P on a side of vehicle B away from the vehicle A is impossible to be sensed by vehicle A, and in this case, the region P is referred to as the sensing blind region for the vehicle A. However, if an emergency occurs in the region P, for example, a pedestrian suddenly appears, a traffic accident is likely to occur.

It should be noted that the term “key road node” refers to a key position on a road, such as an intersection, a corner (a position around the corner), a three-way intersection, a crosswalk, or the like.

The on-vehicle device may detect the distance between the on-vehicle device and the key road node by using a device such as a distance sensor or an on-vehicle positioning device. For example, the on-vehicle device may detect the distance between the on-vehicle device and a marker (such as a traffic light) at the key road node. It is understood that the distance sensor has a detection distance, and the predetermined distance described above is smaller than the detection distance. For example, the predetermined distance is 100 m, 80 m, 50 m or 20 m. When performing global path planning, an autonomous vehicle will mark special sections in the system, such as intersections, corners, three-way intersections, crosswalks, school sections, accident-prone sections, etc. In a case where the on-vehicle positioning device obtains a certain distance between the on-vehicle device and the special section, for example, the on-vehicle positioning device may obtain the distance between the on-vehicle device and a marker at the key road node of a road by positioning information, and the marker comprises a traffic light, a zebra crossing, an entrance and an exit of a school and other positions.

The distance between the on-vehicle device and the key road node in Step S10 may be referred to as the distance between the on-vehicle device and the key road node in front of the vehicle.

In addition, it should be noted that the “around” the on-vehicle device refers to a range defined by taking the on-vehicle device as a center and taking a first predetermined value as a radius. The first predetermined value may be a detection distance where a sensor of the on-vehicle device detects road condition information around the on-vehicle device. Alternatively, the first predetermined value is smaller than the detection distance.

Step S20 includes acquiring, by the on-vehicle device, road condition information of the sensing blind region acquired by an auxiliary equipment.

The auxiliary equipment is an equipment capable of sensing road condition information of at least partial region in the sensing blind region. The auxiliary equipment may include: a road detection device such as a camera fixed above a road, and an on-vehicle device on another vehicle. For example, when the auxiliary equipment includes a road detection device, the on-vehicle device may establish a connection with the road detection device by sending a request to the road detection device, and receive the road condition information sent by the road detection device.

Step S30 including preforming a driving guidance, by the on-vehicle device, based on the road condition information acquired by the on-vehicle device and the road condition information of the sensing blind region.

In the embodiments of the present disclosure, when the on-vehicle device detects that there is the sensing blind region, the road condition information of the sensing blind region acquired by the auxiliary equipment may be obtained, so that the on-vehicle device can acquire complete road condition information, thereby ensuring safe driving of the vehicle. In addition, in the embodiments of the present disclosure, the on-vehicle device performs detection of the sensing blind region not in real time, but detects whether the sensing blind region is present when the on-vehicle device is near the key road node, thereby saving the power consumption of the on-vehicle device.

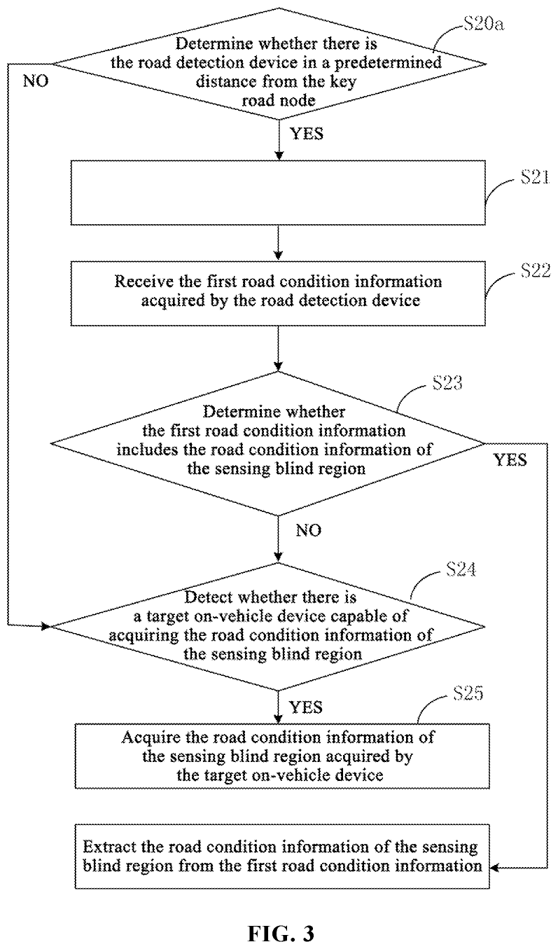

In some embodiments, the auxiliary equipment comprises at least: a road detection device around the on-vehicle device. FIG. 3 is a flowchart of an optional implementation of Step S20 according to some embodiments of the present disclosure. As shown in FIG. 3, Step S20 includes: Step S20a of determining whether there is the road detection device in a predetermined distance from the key road node, if so, executing Step S21; if not, executing Step S24.

Step S21 includes sending first request information to the road detection device to request to obtain first road condition information acquired by the road detection device. When receiving the first request information, the road detection device may establish a connection with the on-vehicle device that sends the first request information, and send the road condition information to the on-vehicle device. The first road condition information may include road condition information of all regions acquired by the road detection device.

Step S22 includes receiving the first road condition information acquired by the road detection device.

Step S23 includes determining whether the first road condition information includes the road condition information of the sensing blind region, if so, extracting the road condition information of the sensing blind region from the first road condition information; if not, executing Step S24.

Specifically, the on-vehicle device may perform the following operation: determining the sensing blind region that is around the vehicle based on the road condition information acquired by the sensor of the on-vehicle device; detecting road detection devices that are near the sensing blind region simultaneously; determining one or more road detection devices which cover the sensing blind region based on the road condition information acquired by the road detection devices, so as to obtain the road condition information of the sensing blind region. The “one or more road detection devices which cover the sensing blind region” refer to one or more road detection devices of which the sensing range may cover the sensing blind region.

In some embodiments, the position information of the current vehicle may be acquired by the on-vehicle positioning device, meanwhile, the road condition information around the current vehicle may be acquired by using an on-vehicle sensor (or a sensor of the on-vehicle device), and when there is a sensing blind region, the system may determine the position of the sensing blind region (such as the distance between the vehicle and the sensing blind region) and the range of the sensing blind region based on the current position information and the acquired sensing blind region. For example, the range of the sensing blind region may be estimated by presetting a moving region of a traffic participant or acquiring the road width of a lane, a sidewalk, or the like through map information. The sensing range of the currently existing road detection devices may be retrieved, and the road detection device capable of covering (or sensing) the sensing blind region may be selected.

Step S24 includes detecting whether there is a target on-vehicle device capable of acquiring the road condition information of the sensing blind region, if so, executing Step S25.

The on-vehicle device may detect other on-vehicle devices based on the relative position relationship between the on-vehicle device and the sensing blind region, and determine whether there is an on-vehicle device capable of acquiring the road condition information of the sensing blind region based on a detection result. For example, when the sensing blind region is located in front left of the on-vehicle device, it is detected whether there are other on-vehicle devices capable of establishing connection with the on-vehicle device in just front, left side, and front left of the on-vehicle device, and if so, at least one of the on-vehicle devices is considered as the target on-vehicle device.

Step S25 includes acquiring the road condition information of the sensing blind region acquired by the target on-vehicle device.

That is to say, when the road condition information of the sensing blind region is obtained, the road condition information is preferentially obtained from the road condition information acquired by the road detection device. Generally, the sensing range of the road detection device is wider, so that the processing efficiency can be improved by preferably obtaining the road condition information from the road detection device.

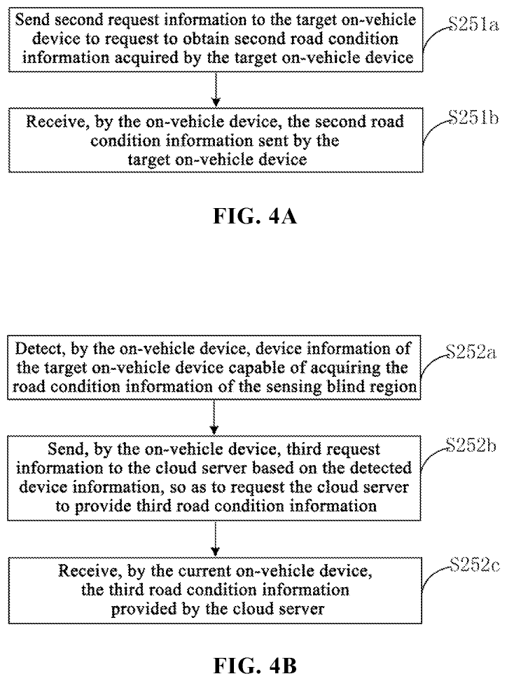

FIG. 4A is a flowchart of an optional implementation of Step S25 according to some embodiments of the present disclosure, and as shown in FIG. 4A, in some embodiments, Step S25 may specifically include Steps S251a to S251b.

Step S251a includes sending second request information to the target on-vehicle device to request to obtain second road condition information acquired by the target on-vehicle device, and the second road condition information includes the road condition information of the sensing blind region.

Specifically, the second request information may include position information of the on-vehicle device.

For example, when the on-vehicle device of vehicle A detects that there is vehicle B around vehicle A and determines that vehicle B may acquire road condition information of the sensing blind region based on the position relationship between vehicle A and the sensing blind region, the on-vehicle device of vehicle A sends the second request information to the on-vehicle device of vehicle B. When receiving the second request information, the on-vehicle device of vehicle B may send all the road condition information acquired by vehicle B to vehicle A, or send a part of the road condition information acquired by vehicle B to vehicle A based on the position relationship between vehicle A and vehicle B. For example, the on-vehicle device of vehicle B determines that a region on a side of vehicle B away from vehicle A, includes the sensing blind region for vehicle A, and sends the road condition information of the region to vehicle A.

For another example, the on-vehicle device of vehicle A detects that there is vehicle B around vehicle A, and since vehicle B travels on the leftmost lane or the rightmost lane, vehicle B inevitably shields other vehicles in travel at this time, and when vehicle B approaches the marker, the communication authority of the on-vehicle device is turned on, and when a vehicle requires a certain part of road condition information (for example, vehicle A requires a certain part of road condition information), vehicle A may establish communication connection with vehicle B, and the road condition information acquired by vehicle B is transmitted.

Step S251b includes receiving, by the on-vehicle device, the second road condition information sent by the target on-vehicle device.

FIG. 4B is a flowchart of an optional implementation of Step S25 according to other embodiments of the present disclosure. As shown in FIG. 4B, in other embodiments, the road condition information acquired by each on-vehicle device may be shared in the cloud server, and in this case, Step S25 may specifically include Steps S252a to S252c:

Step S252a includes detecting, by the on-vehicle device, device information of the target on-vehicle device capable of acquiring the road condition information of the sensing blind region.

The device information may be an ID number unique to the device. For example, the on-vehicle device may transmit a detection signal to a direction close to the sensing blind region. After receiving the detection signal, the target on-vehicle device may feed back response information to the on-vehicle device, the response information includes device information of the device itself.

Step S252b includes sending, by the on-vehicle device, third request information to the cloud server based on the detected device information, so as to request the cloud server to provide third road condition information. The third road condition information includes the road condition information of the sensing blind region acquired by the target on-vehicle device.

The cloud server may provide road condition information in all directions acquired by the corresponding on-vehicle device based on the device information, or may extract road condition information of the sensing blind region from all the road condition information acquired by the target on-vehicle device based on the relative position relationship between the on-vehicle devices. Alternatively, the on-vehicle device directly acquires the road condition information corresponding to the current position from the cloud server based on the current position information.

Step S252c includes receiving, by the on-vehicle device, the third road condition information provided by the cloud server.

In some embodiments, when the vehicle travels a certain distance from the marker, the on-vehicle device may start a sharing function, and upload shared information to the cloud server. The shared information may include current time, current position information, and road condition information corresponding to the current position information. The current position information may include a current distance between the vehicle and the marker.

For example, when a vehicle driving on the rightmost lane has a certain distance from the marker, the acquired current position information and the information of the vehicles and pedestrians on the non-motor vehicle lane or the sidewalk acquired by the sensor are packaged and shared to the cloud server. The shared information may also include device information, such as a device ID, of the vehicle that provides the information.

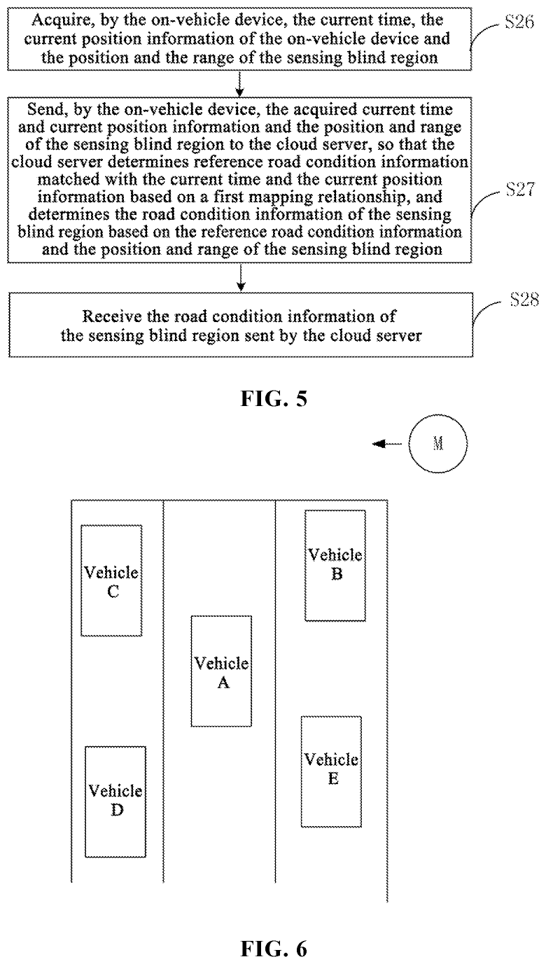

In this case, the cloud server may establish a mapping relationship based on the current time, the current position information, and the road condition information shared by the on-vehicle device; when vehicle A drives to the position X at time t, if the on-vehicle device of vehicle A detects that there is a sensing blind region, the cloud server may acquire road condition information matched with the time t and the position X based on the mapping relationship, and determine the road condition information of the sensing blind region based on the road condition information. Specifically, FIG. 5 is a flowchart of an optional implementation of Step S20 according to other embodiments of the present disclosure, and referring to FIG. 5, Step S20 may specifically include the following Steps S26 to S28.

Step S26 includes acquiring, by the on-vehicle device, the current time, the current position information of the on-vehicle device and the position and the range of the sensing blind region.

Step S27 includes sending, by the on-vehicle device, the acquired current time and the current position information and the position and range of the sensing blind region to the cloud server, so that the cloud server determines reference road condition information matched with the current time and the current position information based on a first mapping relationship, and determines the road condition information of the sensing blind region based on the reference road condition information and the position and range of the sensing blind region.

The first mapping relationship is a mapping relationship among current time, current position and road condition information which are sent to the cloud server by other devices.

Step S28 includes receiving the road condition information of the sensing blind region sent by the cloud server.

It should be noted that the “reference road condition information matched with the current time and the current position information” may be road condition information shared to the cloud server by the vehicles passing through the current position within a predetermined time period before the current time. The predetermined time period is, for example, a time period of 30 seconds, 1 minute, 2 minutes, 5 minutes, 10 minutes, or the like.

For example, when vehicles B, C, and D pass through the position X respectively and the distance between the position X and the key road node is less than the predetermined distance, the on-vehicle devices of vehicles B, C, and D start the information sharing function, package the current time (i.e., the time when each vehicle passes through the position X), the current position information, the acquired road condition information, and the device information, and upload the packaged information to the cloud server. When vehicle A drives to the position X and detects there is a sensing blind region, the on-vehicle device of vehicle A sends the current time to, the current position, the position and the range of the sensing blind region to the cloud server. Assuming that the cloud server detects that vehicle B passes through position X at time t1 before to, the cloud server acquires the road condition information shared by vehicle B, obtains the road condition information of the sensing blind region for vehicle A from the road condition information, and sends it to the on-vehicle device of vehicle A.

In some embodiments, the data sharing method further includes Step S40.

Step S40 includes sending at least part of road condition information acquired by the on-vehicle device to an information request device in response to fourth request information sent by the target on-vehicle device. The information request device is an on-vehicle device which sends the fourth request information.

That is to say, when the on-vehicle device of vehicle A determines that there is the sensing blind region, the on-vehicle device may send a request to the target on-vehicle device to obtain the road condition information acquired by the target on-vehicle device; similarly, the on-vehicle device of vehicle A may also receive the request information sent by the target on-vehicle device, so as to send at least part of the road condition information acquired by the on-vehicle device of vehicle A to the information request device.

In some embodiments, Step S40 may specifically include: sending all the road condition information acquired by the on-vehicle device to the information request device in response to the fourth request information.

In other embodiments, Step S40 may specifically include: detecting the position relationship between the on-vehicle device and the information request device, and determining a demand region of the information request device based on the position relationship; and then, selecting the road condition information corresponding to the demand region from all the road condition information acquired by the on-vehicle device, and sending the road condition information to the information request device.

The demand region at least includes the sensing blind region of the information request device. For example, vehicle A is located in the front left of vehicle B, and when the on-vehicle device of vehicle B functions as the information request device, vehicle A may take the left side region thereof as the demand region of the on-vehicle device of vehicle B.

In some embodiments, the data sharing method may further include: at least when the distance between the on-vehicle device and the key road node is smaller than the predetermined distance, the road condition information acquired by the on-vehicle device is sent to the cloud server, so that other on-vehicle devices can acquire the road condition information acquired by the on-vehicle device from the cloud server.

For example, the road condition information acquired by the on-vehicle device may be sent to the cloud server only when the distance between the on-vehicle device and the key road node is smaller than the predetermined distance; alternatively, the road condition information acquired by the on-vehicle device may be sent to the cloud server in real time during the whole driving process of the vehicle where the on-vehicle device is located.

In some embodiments, the data sharing method may further include: sending reminding information in response to the emergency information acquired by the on-vehicle device, so as to remind other vehicles of performing emergency treatment such as deceleration.

Specifically, during driving, the on-vehicle device may monitor road condition information in real time around the vehicle, and send the reminding information to the surroundings when detecting emergency information (e.g., emergency braking of a vehicle ahead, sudden entry of a pedestrian into a lane, etc.). The reminding information may be broadcasted outward. The reminder information may include the emergency information and may also include emergency treatment results based on the emergency.

FIG. 6 is a schematic diagram of driving of a vehicle according to some embodiments of the present disclosure. As shown in FIG. 6, in an example, vehicles A to E drive on lanes, and when a pedestrian suddenly breaks into a lane in a region M, an on-vehicle device of vehicle B firstly monitors the emergency and timely performs emergency processing (such as deceleration); meanwhile, the emergency information or the emergency treatment result is broadcasted, so that other vehicles are reminded to decelerate.

FIG. 7 is a schematic diagram of a data sharing method according to other embodiments of the present disclosure. The method is applied to a cloud server, and the cloud server is applied to an internet-of-vehicle system, in which on-vehicle devices of vehicles send the road condition information detected by the on-vehicle devices to the cloud server.

As shown in FIG. 7, the data sharing method includes Steps S60 to S70.

In Step S60, the cloud server receives request information sent by the first on-vehicle device. The request information is information that requests the road condition information of the sensing blind region; and the request information includes: the position and range of the sensing blind region.

In Step S70, the cloud server at least sends the road condition information of the sensing blind region acquired by a second on-vehicle device to the first on-vehicle device based on the request information. The second on-vehicle device is an on-vehicle device capable of acquiring the road condition information in the sensing blind region.

In some embodiments, the request information further includes device information of the first on-vehicle device and the second on-vehicle device. Step S70 may specifically include: Step S71 of sending, by the cloud server, all road condition information acquired by the second on-vehicle device to the first on-vehicle device based on the request information.

In other embodiments, the request information includes: the position and range of the sensing blind region. In this case, Step S70 may specifically include Steps S72˜ S73.

In Step S72, the cloud server determines the road condition information of the sensing blind region from all the road condition information acquired by the second on-vehicle device based on the request information.

In Step S73, the cloud server sends the road condition information of the sensing blind region to the first on-vehicle device.

Certainly, the request information may also include the position information of the first on-vehicle device, but not include the position and the range of the sensing blind region, and in this case, the cloud server may determine the position and the range of the sensing blind region based on the position relationship between the first on-vehicle device and the second on-vehicle device, determine the road condition information of the sensing blind region from all the road condition information acquired by the second on-vehicle device, and then send the road condition information of the sensing blind region to the first on-vehicle device.

In other embodiments, before receiving the request information sent by the first on-vehicle device, the cloud server may further establish the first mapping relationship based on the current time, the current position, and the road condition information uploaded by the other on-vehicle devices.

The request information sent by the first on-vehicle device may further include the current position information of the first on-vehicle device, and the cloud server sends the road condition information, which is shared by other on-vehicle devices and corresponds to the position of the first on-vehicle device, to the first on-vehicle device based on the request information. Specifically, the cloud server may determine, based on the first mapping relationship, reference road condition information that matches current time and current position information sent by the first on-vehicle device (the reference road condition information is road condition information that is uploaded to the cloud server by other on-vehicle devices and matches time and position sent by the first on-vehicle device), and determine, based on the reference road condition information and the position and range of the sensing blind region, road condition information of the sensing blind region; and then, send the road condition information of the sensing blind region to the first on-vehicle device.

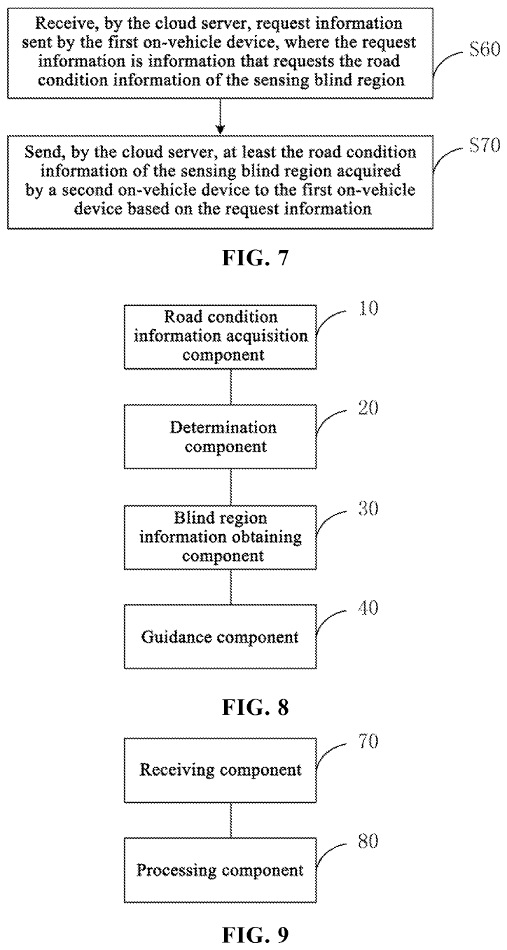

FIG. 8 is a schematic diagram of an on-vehicle device according to some embodiments of the present disclosure. As shown in FIG. 8, the on-vehicle device includes: a road condition information acquisition component 10, a determination component 20, a blind region information obtaining component 30 and a guidance component 40.

The road condition information acquisition component 10 is configured to acquire road condition information.

The determination component 20 is configured to, in a case where a distance between the on-vehicle device and a key road node is smaller than a predetermined distance, determine whether there is a sensing blind region around the key road node based on the road condition information acquired by the on-vehicle device.

The blind region information obtaining component 30 is configured to obtain road condition information of the sensing blind region acquired by an auxiliary equipment in a case where there is the sensing blind region around the road key node.

The guidance component 40 is configured to guide driving based on the road condition information acquired by the road condition information acquisition component 10 and the road condition information of the sensing blind region.

In some embodiments, the auxiliary equipment includes at least: a road detection device around the key road node. The blind region information obtaining component 30 is specifically configured to determine whether there is a road detection device within a predetermined distance from the road key node, and if so, send first request information to the road detection device to request to obtain first road condition information acquired by the road detection device; receive the first road condition information acquired by the road detection device; and if there is no road detection device within the predetermined distance from the key road node, detect whether there is a target on-vehicle device capable of acquiring the road condition information of the sensing blind region.

In some embodiments, the blind region information obtaining component 30 is further configured to determine whether the first road condition information includes complete road condition information of the sensing blind region, and if not, detect whether there is a target on-vehicle device capable of acquiring the road condition information of the sensing blind region; and if there is the target on-vehicle device capable of acquiring the road condition information of the sensing blind region, obtain the road condition information of the sensing blind region acquired by the target on-vehicle device.

In some embodiments, the step of obtaining, by the blind region information obtaining component 30, the road condition information of the sensing blind region acquired by the target on-vehicle device specifically includes: sending second request information to the target on-vehicle device to request the target on-vehicle device to provide second road condition information, the second road condition information including the road condition information of the sensing blind region; and receiving the second road condition information sent by the target on-vehicle device.

In other embodiments, the step of obtaining, by the blind region information obtaining component 30, the road condition information of the sensing blind region acquired by the target on-vehicle device specifically includes: detecting device information of the target on-vehicle device capable of acquiring the road condition information of the sensing blind region; sending third request information to the cloud server based on the device information to request the cloud server to provide third road condition information, the third road condition information including the road condition information of the sensing blind region acquired by the target on-vehicle device; and receiving the third road condition information provided by the cloud server.

In some embodiments, the step of obtaining, by the blind region information obtaining component 30, the road condition information of the sensing blind region acquired by the auxiliary equipment specifically includes: acquiring current time, current position information of the on-vehicle device and the position and the range of the sensing blind region; sending the current time, the current position information and the position and the range of the sensing blind region to the cloud server, so that the cloud server determines reference road condition information matched with the current time and the current position information based on the first mapping relationship, and determines the road condition information of the sensing blind region based on the reference road condition information and the position and the range of the sensing blind region; and receiving the road condition information of the sensing blind region sent by the cloud server. The first mapping relationship is a mapping relationship among current time, current position and road condition information sent to the cloud server by other devices.

In some embodiments, the on-vehicle device further includes: a reminding component configured to send a reminding signal in response to the emergency information acquired by the on-vehicle device.

FIG. 9 is a schematic diagram of a cloud server according to some embodiments of the present disclosure. As shown in FIG. 9, the cloud server includes: a receiving component 70 and a processing component 80. The receiving component 70 is configured to receive the request information sent by the first on-vehicle device. The request information is information for requesting the road condition information of the sensing blind region; and the request information includes: the position and the range of the sensing blind region. The processing component 80 is configured to send at least the road condition information of the sensing blind region acquired by the second on-vehicle device to the first on-vehicle device based on the request information.

In some embodiments, the request information further includes: device information of the second on-vehicle device; the processing component 80 is specifically configured to send all the road condition information acquired by the second on-vehicle device to the first on-vehicle device based on the request information.

In other embodiments, the request information includes position information of the sensing blind region; the processing component is specifically configured to determine the road condition information of the sensing blind region from all the road condition information acquired by the second on-vehicle device based on the request information, and send the road condition information of the sensing blind region to the first on-vehicle device.

In other embodiments, the request information further includes: current time and current position information of the first on-vehicle device. The processing component is specifically configured to establish a first mapping relationship based on current time, current position and road condition information uploaded by other on-vehicle devices prior to receiving the request information sent by the first on-vehicle device; subsequent to receiving the request information, determine the reference road condition information matched with the current time and the current position information based on the first mapping relationship, and determine the road condition information of the sensing blind region based on the reference road condition information and the position and the range of the sensing blind region; and send the road condition information of the sensing blind region to the first on-vehicle device.

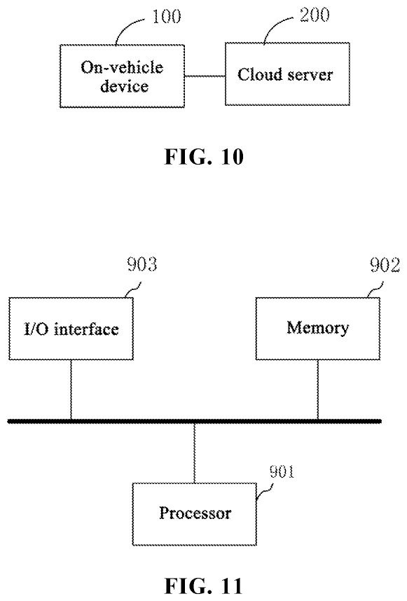

FIG. 10 is a schematic diagram of an internet-of-vehicle system according to some embodiments of the present disclosure. As shown in FIG. 10, the internet-of-vehicle system includes the on-vehicle device 100 described above and the cloud server 200 described above. In addition, the internet-of-vehicle system may also include a road detection device.

FIG. 11 is a schematic diagram of an electronic apparatus according to some embodiments of the present disclosure. As shown in FIG. 11, the electronic apparatus includes: one or more processors 901; a memory 902 on which one or more programs are stored, wherein when executed by the one or more processors, the one or more programs cause the one or more processors to implement the data sharing method of any of the above embodiments; and one or more I/O interfaces 903 coupled between the one or more processors and the memory and configured to implement information interaction between the one or more processors and the memory.

Each processor 901 is a device with data processing capability, which includes but is not limited to a central processing unit (CPU), etc.; the memory 902 is a device having data storage capability, which includes but is not limited to a random access memory (RAM, more specifically SDRAM, DDR, etc.), a read only memory (ROM), an electrically erasable programmable read only memory (EEPROM), a flash memory (FLASH); one or more I/O interfaces (read/write interfaces) 903 are coupled between the one or more processors 901 and the memory 902, may implement information interaction between the one or more processors 901 and the memory 902, and include but are not limited to a data bus (Bus) and the like.

In some embodiments, the one or more processors 901, the memory 902, and the one or more I/O interfaces 903 are coupled to each other by a bus and are coupled to other components of a computing device.

Embodiments of the present disclosure also provide a computer readable medium, on which a computer program is stored, and when the program is executed by a processor, the computer program implements the data sharing method provided by the present embodiments.

It will be understood by one of ordinary skill in the art that all or some of the steps of the methods, systems, functional components/units in the devices disclosed above may be implemented as software, firmware, hardware, or suitable combinations thereof. In a hardware implementation, the division between functional components/units mentioned in the above description does not necessarily correspond to the division of physical components; for example, one physical component may have multiple functions, or one function or step may be performed by several physical components in cooperation. Some or all of the physical components may be implemented as software executed by a processor, such as a central processing unit, a digital signal processor, or a microprocessor, or may be implemented as hardware, or may be implemented as an integrated circuit, such as an application specific integrated circuit. Such software may be distributed on computer readable medium, which may include computer storage medium (or non-transitory medium) and communication medium (or transitory medium). The term computer storage medium includes volatile and nonvolatile, removable and non-removable medium implemented in any method or technology for storage of information such as computer readable instructions, data structures, program modules or other data, as is well known to one of ordinary skill in the art. The computer storage medium includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which can be accessed by a computer. In addition, the communication medium typically includes computer readable instructions, data structures, program modules or other data in a modulated data signal such as a carrier wave or other transport mechanism and may include any information delivery medium, as is well known to one of ordinary skill in the art.

It should be noted that herein, the term “comprise”, “include” or any other variation thereof is intended to cover a non-exclusive inclusion, such that a process, method, article, or device that includes a list of elements does not include only those elements but may include other elements not expressly listed or inherent to such process, method, article, or device. Without further limitation, an element identified by the phrase “comprising an/a . . . ” does not exclude the presence of other identical elements in the process, method, article, or device that includes the element.

It will be understood that the above embodiments are merely exemplary embodiments employed to illustrate the principles of the present disclosure, and the present disclosure is not limited thereto. It will be apparent to one of ordinary skill in the art that various changes and modifications can be made therein without departing from the spirit and scope of the present disclosure, and these changes and modifications are to be considered within the scope of the present disclosure.

1. A data sharing method applied to an on-vehicle device, comprising:
determining whether there is a sensing blind region around the on-vehicle device based on road condition information acquired by the on-vehicle device in response to a distance between the on-vehicle device and a key road node being smaller than a predetermined distance;
in response to there being the sensing blind region around the on-vehicle device, obtaining road condition information of the sensing blind region acquired by an auxiliary equipment; and
performing a driving guidance based on the road condition information acquired by the on-vehicle device and the road condition information of the sensing blind region.

2. The method of claim 1, wherein the auxiliary equipment at least comprises: a road detection device, and
the obtaining of the road condition information of the sensing blind region acquired by the auxiliary equipment comprises:
determining whether there is the road detection device in a preset distance from the key road node,
sending first request information to the road detection device to request to obtain first road condition information acquired by the road detection device, in response to there being the road detection device in the preset distance from the key road node;
receiving the first road condition information acquired by the road detection device; and
detecting whether there is a target on-vehicle device capable of acquiring the road condition information of the sensing blind region in response to there being no road detection device in the preset distance from the key road node.

3. The method of claim 2, further comprising:
determining whether the first road condition information comprises the road condition information of the sensing blind region,
detecting whether there is a target on-vehicle device capable of acquiring the road condition information of the sensing blind region in response to the first road condition information not comprising the road condition information of the sensing blind region; and
obtaining the road condition information of the sensing blind region acquired by the target on-vehicle device, in response to there being the target on-vehicle device.

4. The method of claim 3, wherein the obtaining of the road condition information of the sensing blind region acquired by the target on-vehicle device, comprises:
sending second request information to the target on-vehicle device to request the target on-vehicle device to provide second road condition information, wherein the second road condition information comprises the road condition information of the sensing blind region; and
receiving the second road condition information provided by the target on-vehicle device.

5. The method of claim 3, wherein the obtaining of the road condition information of the sensing blind region acquired by the target on-vehicle device comprises:
detecting device information of the target on-vehicle device;
sending third request information to a cloud server based on the device information to request the cloud server to provide third road condition information, wherein the third road condition information comprises the road condition information of the sensing blind region acquired by the target on-vehicle device; and
receiving the third road condition information provided by the cloud server.

6. The method of claim 1, wherein the obtaining of the road condition information of the sensing blind region acquired by the auxiliary equipment comprises:
acquiring current time, current position information of the on-vehicle device and a position and a range of the sensing blind region;
sending the current time, the current position information and the position and the range of the sensing blind region to a cloud server, so that the cloud server determines reference road condition information matched with the current time and the current position information based on a first mapping relationship, and determines the road condition information of the sensing blind region based on the reference road condition information and the position and the range of the sensing blind region; and
receiving the road condition information of the sensing blind region sent by the cloud server, wherein
the first mapping relationship indicates a mapping relationship among the current time, the current position and the road condition information sent to the cloud server by other on-vehicle devices.

7. The method of claim 1, further comprising:
sending reminding information in response to an emergency information acquired by the on-vehicle device.

8. A data sharing method applied to a cloud server, comprising:
receiving request information sent by a first on-vehicle device, wherein the request information is information that requests road condition information of a sensing blind region, and the request information includes: a position and a range of the sensing blind region; and
sending at least the road condition information of the sensing blind region acquired by a second on-vehicle device to the first on-vehicle device based on the request information.

9. The method of claim 8, wherein the request information further comprises: device information of the second on-vehicle device; and
the sending of at least the road condition information of the sensing blind region acquired by the second on-vehicle device to the first on-vehicle device based on the request information comprises:
sending all road condition information acquired by the second on-vehicle device to the first on-vehicle device based on the request information.

10. The method of claim 9, wherein the sending of at least the road condition information of the sensing blind region acquired by the second on-vehicle device to the first on-vehicle device based on the request information comprises:
determining road condition information of the sensing blind region from the all road condition information acquired by the second on-vehicle device based on the request information; and
sending the road condition information of the sensing blind region to the first on-vehicle device.

11. The method of claim 8, further comprising: prior to receiving the request information sent by the first on-vehicle device, establishing a first mapping relationship based on current time, current position and road condition information uploaded by other on-vehicle devices, wherein
the request information further comprises: the current time and the current position information of the first on-vehicle device,
the sending of at least the road condition information of the sensing blind region acquired by the second on-vehicle device to the first on-vehicle device based on the request information comprises:
determining reference road condition information matched with the current time and the current position information based on the first mapping relationship, and determining the road condition information of the sensing blind region based on the reference road condition information and the position and the range of the sensing blind region; and
sending the road condition information of the sensing blind region to the first on-vehicle device.

12. An on-vehicle device, comprising:
a road condition information acquisition component configured to acquire road condition information;
a determination component configured to, in response to a distance between the on-vehicle device and a key road node being smaller than a predetermined distance, determine whether there is a sensing blind region around the on-vehicle device based on the road condition information acquired by the on-vehicle device;
a blind region information obtaining component configured to obtain road condition information of the sensing blind region acquired by an auxiliary equipment in a case where there is the sensing blind region around the on-vehicle device; and
a guidance component configured to perform a guidance driving based on the road condition information acquired by the road condition information acquisition component and the road condition information of the sensing blind region.

13. A cloud server, comprising: a receiving component and a sending component,
wherein the receiving component and the sending component are configured to collectively perform the method of claim 8.

14. An internet-of-vehicle system, comprising: an on-vehicle device and the cloud server of claim 13,
wherein the on-vehicle device comprises:
a road condition information acquisition component configured to acquire road condition information;
a determination component configured to, in response to a distance between the on-vehicle device and a key road node being smaller than a predetermined distance, determine whether there is a sensing blind region around the on-vehicle device based on the road condition information acquired by the on-vehicle device;
a blind region information obtaining component configured to obtain road condition information of the sensing blind region acquired by an auxiliary equipment in a case where there is the sensing blind region around the on-vehicle device; and
a guidance component configured to perform a guidance driving based on the road condition information acquired by the road condition information acquisition component and the road condition information of the sensing blind region.

15. An electronic apparatus, comprising:
one or more processors;
a memory having one or more programs stored thereon that, when executed by the one or more processors, cause the one or more processors to implement the method of any claim 1;
one or more I/O interfaces coupled between the one or more processors and the memory and configured to implement information interaction between the one or more processors and the memory.

16. A non-transitory computer-readable storage medium, on which a computer program is stored, wherein when being executed by a processor, the computer program implements the method of claim 1.

17. A non-transitory computer-readable storage medium, on which a computer program is stored, wherein when being executed by a processor, the computer program implements the method of claim 2.

18. A non-transitory computer-readable storage medium, on which a computer program is stored, wherein when being executed by a processor, the computer program implements the method of claim 3.

19. A non-transitory computer-readable storage medium, on which a computer program is stored, wherein when being executed by a processor, the computer program implements the method of claim 4.

20. A non-transitory computer-readable storage medium, on which a computer program is stored, wherein when being executed by a processor, the computer program implements the method of claim 5.
